(19) United States
(12) Patent Application Publication
(10) Pub. No.: US 2021/0009394 A1
(43) Pub. Date: Jan. 14, 2021

(54) ROBOTIC END EFFECTOR FOR GRIPPING AND TIGHTENING CONTAINER CAPS

(71) Applicant: Luther J. Vann, JR., West Columbia, SC (US)

(72) Inventor: Luther J. Vann, JR., West Columbia, SC (US)

(21) Appl. No.: 16/507,738

(22) Filed: Jul. 10, 2019

(51) Int. Cl. B67B 3/20

(52) U.S. Cl. CPC B67B 3/2066; B25J 15/0038; B67B 3/202

(57) ABSTRACT

A gripper on an end effector of a robotic arm tightens caps onto a containers. Two or more such grippers cooperate to grip a cap and position it over the container. The cap is threaded to the container by rotating the cap while holding the container. The curved surface on the gripper conforms to and engages the periphery of the cap. The curved surface has plural apertures formed in it. The gripper has plural interior, partial-cylindrical compartments accessible via removable wall of the gripper. A resilient material, such as a fluoropolymer elastomer in the form of a cylinder fits into the compartments and extends partially through the apertures on the curved side to present plural resilient ribs to frictionally hold the cap during threading. When the resilient material is worn, it may be may be quickly replaced by removing the wall.

### FIELD

This disclosure relates generally to robotic grippers and, in particular, to grippers that tighten caps or lids on containers.

### BACKGROUND

The use of robotic devices with end effectors to perform routine manufacturing tasks is widespread. For example, putting a cap on a container is just such a routine task.

Placing a cap on a container and twisting it to seal the container is important. The product inside the container may have a shelf life that may be compromised by a cap that is loose or not tight, or the contents may be harmful, even dangerous, if the contents spill because the cap was not properly sealed. An example of a group of products that are sold in carefully sealed containers is pharmaceutical medications.

To seal a container with a cap, the top of the container and the inside of the cap may be threaded to permit a tight closure. The cap may be placed on the container and either the cap, the container, or both may be rotated. The threads of the cap advance as the cap is threaded to the container until the cap will advance no further. Containers may be capped by a robotic end effector. A robotic end effector is a device on an electro-mechanical arm that picks up a cap, orients it so the cap's open end is toward the top of the container and, with both cap and container coaxially aligned, advances the cap onto the container. Relative rotational movement between the cap and the container in the appropriate direction advances the cap onto the container. When the force to rotate the cap causes the prior art grippers holding the cap to slip, the cap is deemed to be tight, and the prior art grippers will then open to allow the container to be removed from its cap-tightening position and the process then repeats by fetching another cap for the next container.

The prior art grippers, made of aluminum, which are on the end effector, are able to grip the cap with enough pressure to hold the cap while the container rotates relative to the cap. That level of pressure on the cap is set to allow the cap to slip when the resistance of the cap to the pressure of the prior art grippers indicates that the cap is tight enough to meet specifications.

In an automated production facility, containers are filled as fast as possible and as many containers as can be filled properly are capped and advanced to the next step in the process, such as labeling, packaging and shipping. Productivity depends on the speed of the process as well as the number of units of product that can be capped before parts such as prior art grippers become worn by friction. When prior art grippers are worn, they are discarded and replaced with new prior art grippers.

A reliable, high-performance gripper for end effectors used in capping pharmaceutical containers would be an advantage.

### SUMMARY

According to its major aspects and briefly described, herein is disclosed a gripper for use in tightening a cap onto a container. The present device includes at least two grippers on an end effector of a robotic arm. The two or more grippers cooperate to grip a cap selected from an advancing supply of caps, to position the gripped cap over the next container on the conveyor, and then to thread the cap to the container once the cap makes contact with the container. The end effector rotates the cap as the conveyor holds the container, thereby threading the rotating cap onto the stationary container. When the cap has reached the end of its threaded path, the grippers that were holding the cap will slip because the torque force on the container exceeds the frictional force exerted by the grippers on the cap, and thereby signaling that the cap is tight. The end effector releases the cap and the conveyor removes the capped container.

The improved grippers are attached to the end effector, and are spaced apart. A gripper has an exterior face that is oriented to face the curved side of the cap, and curved to conform to the curved side of the cap, and has a compartment formed in the interior of the gripper. At least two apertures and as many as five narrow, parallel apertures formed in the face of the gripper lead to the compartments, one aperture for each compartment. The compartments may be shaped like partial, right cylindrical compartments, each spaced apart from the other. A resilient material—a natural or synthetic rubber such as a fluoropolymer—is inside each compartment and extends through the apertures, bulging out of the curved face of the gripper as a series of resilient ribs. When the gripper engages the cap, the resilient ribs contact the cap and holds it frictionally as the cap is threaded to the container.

The gripper itself is made of steel, such as stainless steel and has a removable bottom wall secured to the balance of the gripper by at least one steel screw. Removing the screw and then the wall provides access to the compartments in the interior of the gripper to allow replacement of the resilient material, which saves time and money. The steel gripper can be used indefinitely and the resilient material is inexpensive.

These and other features of the disclosure will be apparent to those skilled in end effectors used in manufacturing processes from a careful reading of the Detailed Description accompanied by the following drawings.

### BRIEF DESCRIPTION OF THE DRAWINGS

In the figures,

FIG. 1 illustrates a prior art robotic end effector with a prior art gripper picking up a cap for a container;

FIG. 2 shows the prior art robotic end effector of FIG. 1 after having moved the cap over the container;

FIG. 3 shows the prior art robotic end effector of FIG. 1 having tightened the cap onto the container;

FIG. 4 shows a prior art gripper in a top front perspective view;

FIG. 5 shows the gripper in a top front perspective view;

FIG. 6 is a top view of the gripper for an end effector;

FIG. 7 is a top, right, exploded, perspective view of the gripper;

FIG. 8 is a front view of the gripper; and

FIG. 9 is a back view of the gripper.

### DETAILED DESCRIPTION

Herein is disclosed a device for use in threading a cap to a container as part of an automated system. The container may be formed to receive a cylindrical cap. The device includes at least two grippers on an end effector of a robotic arm, for example, two opposing grippers that cooperate to take the next cap from an advancing supply of caps, position the next cap over the container, and then lower the next cap so it makes contact with the container. While rotating the cap, the end effector continues to lower the rotating cap onto a container, which is on a stationery surface. The cap is thus quickly threaded to the container.

When the cap has reached the end of its threaded path, the grippers that were rotating the cap up to that point will start to slip as the torque force required rises sharply when the cap is fully threaded. The slipping of the grip on the cap signals that the cap is tight. The end effector releases the cap and the conveyor resumes its march on the conveyer with the capped container.

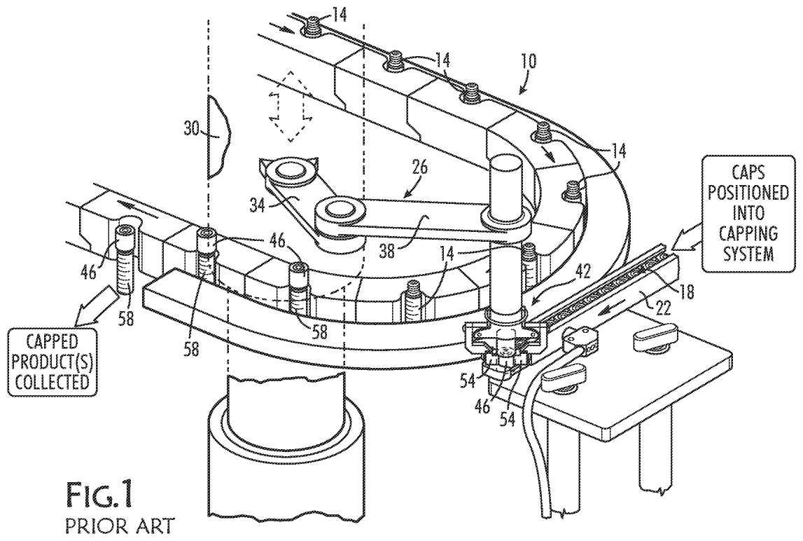

FIGS. 1-3 illustrate a prior art example of the foregoing process. The present process is the same. The grippers, however, are improved over the prior art grippers, as will be described below.

As shown in these figures, a conveyor 10 brings a series of containers 14 near to a series of caps 18 that are advancing toward conveyor 10 in a feed tray 22. A robotic arm 26 extends from a vertical shaft 30, shown in broken lines so that conveyor 10 and other components are not obscured.

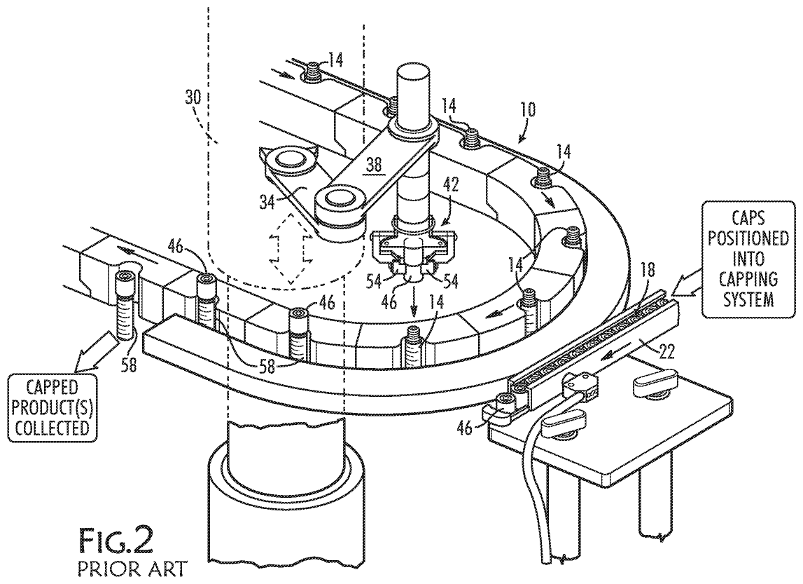

Vertical shaft 30 moves up and down in a programmed sequence, as best seen by comparing FIGS. 2 and 3 and noting the arrows indicating up and down motion. As vertical shaft 30 moves up and down, so does robotic arm 26. Arm 26 has a first link 34 and a second link 38. Second link 38 repeatedly extends toward caps 18 at the end of feed tray 22, and then contracts moving with respect to first link 34 in a path between feed tray 22 and conveyor 10 as it contracts, as best seen by comparing FIGS. 1 and 2. Vertical shaft 30 moves down when second link 38 contracts, and then up when second link 38 extends. This sequence of movements enables an end effector 42 to pick a next cap 46 and move it to a next container 50 on conveyor 10, and then rotate next cap 46 onto next container 50 as container is stationary, whereupon container 58 is capped, and subsequently removed from conveyor 10.

End effector 42 has two positions. It has an open position wherein its grippers 54 are farther apart and a closed position wherein its grippers are closer together. Grippers 54 move to their closed position when end effector 42 is about to lift next cap 46 and then move to their open position to release next cap 46 after next cap 46 has been tightened onto container. End effector 42 has at least two grippers 54 but may have more, operating in a synchronized, opposing manner to grip portions of the side of next cap 46.

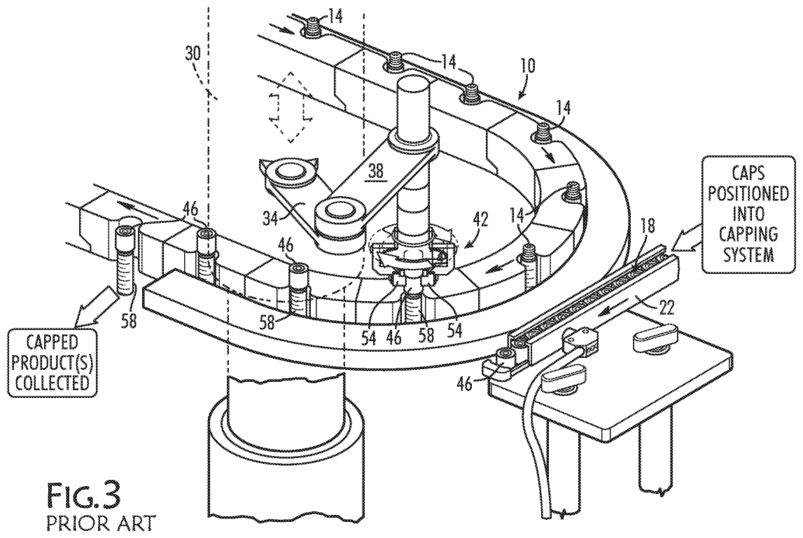

FIG. 4 shows a perspective view of a prior art gripper 62 positioned near cap 66 and mounted to an end effector 70 partially shown in dashed lines. A second prior art gripper identical to prior art gripper 62 would be used in connection with gripper 62 to move and hold cap 66; one gripper 62 is shown in FIG. 4 so a cap-engaging surface 74 of prior art gripper 66 is visible. Cap engaging surface 74 is smooth and curved, and it is made of a hard plastic that is adhered to the balance of gripper 62, which is made of aluminum.

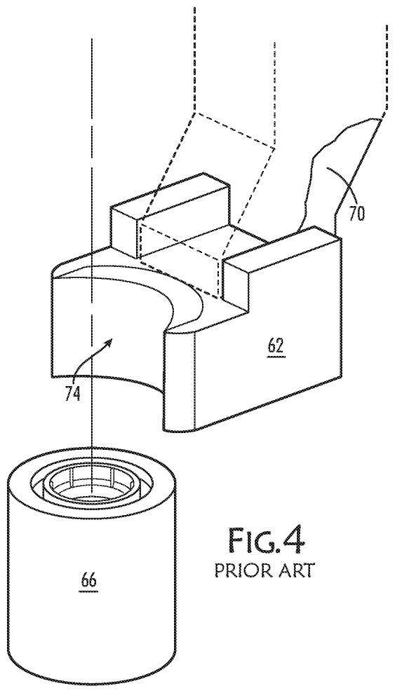

FIG. 5 illustrates a gripper 80 according to the present disclosure. Gripper 80, as with prior art gripper 66, curved and is held by an end effector 84 near a next cap 88 and has a second, opposing gripper not shown to assist it in gripping next cap 88. Unlike prior art gripper 62, gripper 80 has a series 92 of partial cylindrical ribs 92 that will engage next cap 88 when end effector 84 closes on next cap 88. Series may include at least two and may have five cylindrical ribs 96 as shown or a different number that is at least two. Gripper 80 may be made of steel, preferably with stainless steel, with cast rubber used for the resilient inserts.

There may be more than two grippers 80. If two grippers 80, they will be opposing they will be centered 180 degrees apart. Three grippers 80 would be centered 120 degrees apart, and so forth, and the curve of their width would cover a smaller and smaller arc of a circle

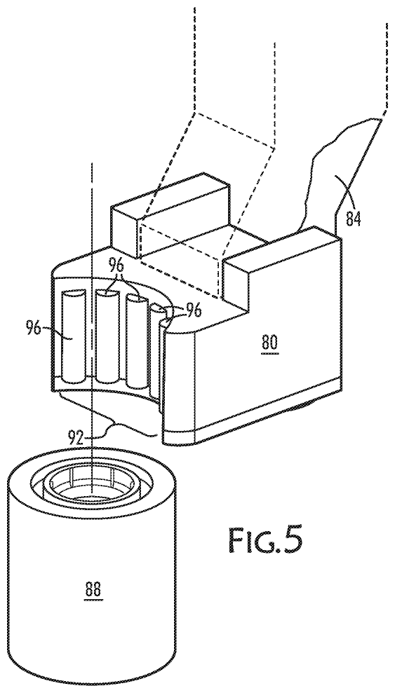

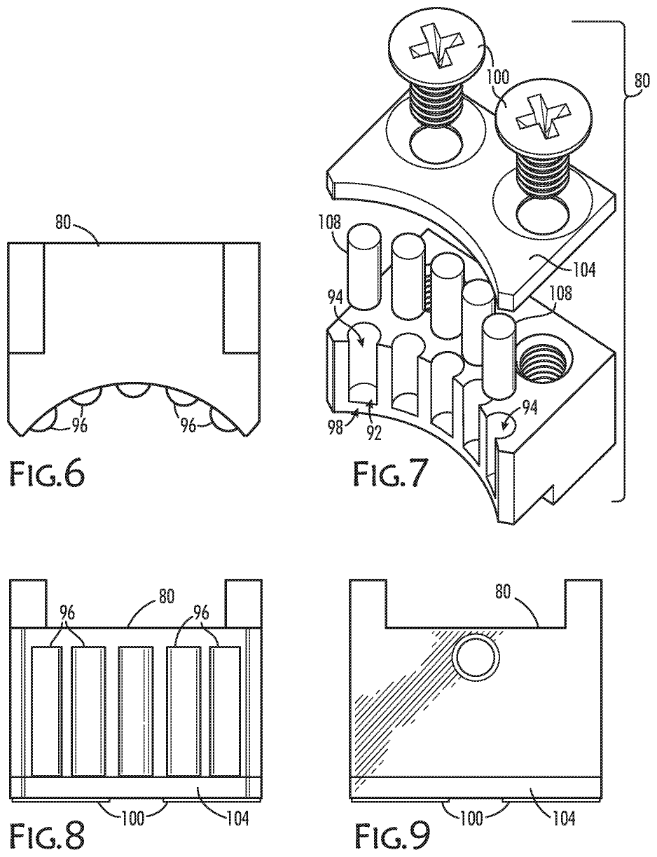

FIGS. 6-9 show a top view; a right, front, exploded view; a front view; and a back view of gripper 80, respectively. Gripper 80 and at least one opposing, spaced-apart, identical gripper are used in connection with an end effector 84, to hold next cap 88 in place during capping of a container as shown in FIGS. 1-3.

Gripper 80 has at least two compartments 94, best seen in FIG. 7, where five compartments 94 are shown. Compartments 94 are accessible by loosening screws 100 that hold a removable bottom 104 to gripper 80 (See FIG. 10) to reveal compartments 94 filled with a resilient material 108. Compartments 94 are partially cylindrical in shape and communicate with the exterior of gripper 80 via apertures 92 on an exterior face 98 of gripper 80 where a portion of resilient material 108 extends through to appear as a curved rib on exterior face 98. Resilient material 108 may be a natural or a synthetic rubber and may be a fluoropolymer elastomer that is cast so that it will emerge from compartment 94 through series of apertures 92 on the exterior face 98 of gripper 80 and can be seen as rounded ribs 96 from the exterior. There may be more than two apertures 92, such as three, four, or five or more apertures 92 depending on the nature of resilient material 108 and the width of apertures in permitting cylindrical ribs that are able to grip next cap 88. A reasonable amount of experimentation with resilient materials and the width, spacing and number of apertures 92 will quickly reveal a suitable number of apertures 92.

Resilient material 108 provides the friction to hold and rotate next cap 88 while next container 14 is held securely with respect to next cap 88. When next cap 88 is tight, gripper 80 will slip. In time, resilient material 108 may be warn and need to be replaced by removing bottom 104 and inserting new resilient material 108 into compartments 94. Removable bottom 104 is then reattached to gripper 80 by screws 100, and gripper 80 can be put back into operation.

Those skilled in the art of robotic manufacturing and in end effectors configured to attach caps and lids will appreciate many modifications and substitutions can be made to the present end effector as shown and described without departing from the scope of the present disclosure.

What is claimed is:

1. A device, having
an end effector;
at least two opposing grippers, said grippers being spaced apart and attached to said end effector, a gripper of said at least two opposing grippers having an exterior with a face and an interior with at least one compartment formed inside said said gripper, and wherein said face includes at least one aperture for communication between said interior of said at least one compartment and said face of said exterior; and
a resilient material in said at least one compartment and emerging through said at least one aperture.

2. The device of claim 1, wherein said resilient material is rubber.

3. The device of claim 1, wherein said resilient material is synthetic rubber.

4. The device of claim 1, wherein said resilient material is a fluoropolymer elastomer.

5. The device of claim 1, wherein said gripper includes at least two apertures.

6. The device of claim 1, wherein said gripper includes at least three apertures.

7. The device of claim 1, wherein said gripper is made of steel.

8. The device of claim 1, wherein said gripper is made of stainless steel.

9. The device of claim 1, wherein said face of said gripper is curved.

10. The device of claim 1, wherein said gripper has a removable wall to provide access to said at least one compartment.

11. The device of claim 10, wherein said removable wall is fastened to said gripper by at least one screw.

12. The device of claim 11, wherein said at least one screw is a steel screw.

13. The device of claim 1, wherein and said resilient material is made of synthetic rubber in said compartment extending through said aperture.

14. The device of claim 1, wherein said gripper has five apertures and said resilient material is five fluoropolymer elastomer cylinders extending through said five apertures from said compartment.

15. The device of claim 1, wherein said face of said gripper is curved to conform to an arc of a cylinder.

16. The device of claim 1, wherein said gripper has a removable wall providing access to said at least one compartment.
